(19) United States
(12) Patent Application Publication
(10) Pub. No.: US 2025/0016803 A1
(43) Pub. Date: Jan. 9, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: Yinan Zhao, Shanghai (CN); CHAO LUO, Shanghai (CN); RENMAO LIU, Shanghai (CN)

(21) Appl. No.: 18/705,547

(22) PCT Filed: Nov. 4, 2022
(86) PCT No.: PCT/CN2022/129861

§ 371 Date: Apr. 27, 2024

(30) Foreign Application Priority Data
Nov. 4, 2021 (CN) 202111302853.7

(51) Int. Cl. H04W 72/40; H04W 72/02; H04W 72/25; H04W 72/54

(52) U.S. Cl. CPC H04W 72/40; H04W 72/02; H04W 72/25; H04W 72/54

(57) ABSTRACT

Provided in the present invention is a method performed by user equipment and user equipment. The method includes: first user equipment transmitting request information to second user equipment at time T; the first user equipment receiving a coordination message; and the first user equipment performing resource selection.

### TECHNICAL FIELD

The present invention relates to the technical field of wireless communications, and in particular to a method performed by user equipment, and corresponding user equipment.

### BACKGROUND

In conventional cellular networks, all communication needs to pass through base stations. By contrast, D2D communication (device-to-device communication, device-to-device direct communication) refers to a direct communication method between two user equipment units without forwarding via a base station or a core network. A research project on the use of LTE equipment to implement proximity D2D communication services was approved at the 3rd Generation Partnership Project (3GPP) RAN #63 plenary meeting in March 2014 (see Non-Patent Document 1). Functions introduced in the LTE Release 12 D2D include:
1) a discovery function between proximate devices in an LTE network coverage scenario;
2) a direct broadcast communication function between proximate devices; and
3) support for unicast and groupcast communication functions at higher layers.

A research project on enhanced LTE eD2D (enhanced D2D) was approved at the 3GPP RAN #66 plenary meeting in December 2014 (see Non-Patent Document 2). Main functions introduced in the LTE Release 13 eD2D include:
1) D2D discovery in out-of-coverage and partial-coverage scenarios; and
2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and is used to implement information exchange between a vehicle and all entities that may affect the vehicle, for the purpose of reducing accidents, alleviating traffic congestion, reducing environmental pollution, and providing other information services. Application scenarios of V2X mainly include four aspects:
1) V2V, Vehicle to Vehicle, i.e., vehicle-to-vehicle communication;
2) V2P, Vehicle to Pedestrian, i.e., a vehicle transmits alarms to a pedestrian or a non-motorized vehicle;
3) V2N: Vehicle-to-Network, i.e., a vehicle connects to a mobile network;
4) V2I: Vehicle-to-Infrastructure, i.e., communication such as that between a vehicle and road infrastructure.

3GPP divides the research and standardization of V2X into three stages. The first stage was completed in September 2016, and mainly focused on V2V and was based on LTE Release 12 and Release 13 D2D (also known as sidelink), that is, the development of proximity communication technologies (see Non-Patent Document 3). V2X stage 1 introduces a new D2D communication interface referred to as a PC5 interface. The PC5 interface is mainly used to address the issue of cellular Internet of Vehicle (IoV) communication in high-speed (up to 250 km/h) and high-node-density environments. Vehicles can exchange information such as position, speed, and direction through the PC5 interface, that is, the vehicles can communicate directly through the PC5 interface. Compared with the proximity communication between D2D devices, functions introduced in LTE Release 14 V2X mainly include:
1) higher density DMRS to support high-speed scenarios;
2) introduction of sub-channels to enhance resource allocation methods; and
3) introduction of a user equipment sensing mechanism having semi-persistent scheduling.

The second stage of the V2X research project belongs to the LTE Release 15 research category (see Non-Patent Document 4). The introduced main features include high-order 64QAM modulation, V2X carrier aggregation, and short TTI transmission, and also include feasibility study on transmit diversity.

The corresponding third stage, a V2X feasibility research project based on 5G NR network technologies (see Non-Patent Document 5), was approved at the 3GPP RAN #80 plenary meeting in June 2018.

In the 5G NR V2X project, user equipment sensing-based resource allocation mode 2, alternatively referred to as transmission mode 2, is supported. In resource allocation mode 2, the physical layer of the user equipment senses transmission resources in a resource pool, and reports a set of available transmission resources to the upper layers. Upon acquiring the report from the physical layer, the upper layers perform resource selection or resource reselection.

A standardization study project based on standardized NR sidelink enhancement (see Non-Patent Document 6) was approved at the 3GPP RAN #90e plenary meeting in December 2020. The sidelink enhancement includes the following three aspects:
1) Standardized resource allocation modes for power consumption reduction (power saving) of sidelink user equipment include, but are not limited to: a resource allocation mode based on partial sensing, and a resource allocation mode based on random resource selection.
2) Research aimed at improving the communication reliability of resource allocation mode 2 in NR sidelink and reducing the communication latency of resource allocation mode 2 includes: inter-UE coordination. The inter-UE coordination indicates that UE A determines a resource set, and transmits (indicates) the resource set to UE B. The resource allocation mode of UE B is resource allocation mode 2, and during resource selection, the resource set indicated by UE A is taken into account.
3) Standardized sidelink (SL) discontinuous reception (SL DRX) mechanisms. In 5G NR communication, user equipment supports temporally discontinuous reception of a physical downlink control channel (PDCCH), referred to as DRX, thereby effectively reducing power consumption of communication devices. Similarly, for SL DRX, discontinuous reception refers to receiving a physical sidelink control channel (PSCCH) within a partial time in the time domain, and the time is referred to as active time, whereas the time within which no PSCCH is received is referred to as in-active time.

In the 3GPP RAN1 #104bis-e meeting in April 2021, the following conclusions were reached regarding inter-UE coordination in resource allocation mode 2 (see Non-Patent Document 7):
The inter-UE coordination supports the following two schemes:
   Inter-UE coordination scheme 1: a coordination message transmitted by UE A to UE B is an indication of a resource set. The resource set includes resources preferred for UE B's transmission, and/or resources non-preferred for UE B's transmission.
   Inter-UE coordination scheme 2: a coordination message transmitted by UE A to UE B indicates that an expected (or potential) resource conflict is present on a resource indicated by SCI transmitted by UE B, and/or indicates that a detected resource conflict is present on a resource indicated by SCI transmitted by UE B.

The solution of the present patent includes a method for resource selection (or reselection) for user equipment B in resource allocation mode 2 in inter-UE coordination scheme 1, and a method used by user equipment A to select a resource for transmitting a coordination message.

### PRIOR ART DOCUMENT

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-181480, New SID Proposal: Study on NR V2X
Non-Patent Document 6: RP-202846, WID revision: NR sidelink enhancement
Non-Patent Document 7: RAN1 #104bis-e, Chairman's notes, section 8.11.1.2

### SUMMARY

In order to address at least part of the aforementioned issues, the present invention provides a method performed by user equipment, and user equipment.

According to a first aspect of the present invention, the method comprises: first user equipment transmitting request information to second user equipment at a time T; the first user equipment receiving a coordination message; and the first user equipment performing resource selection.

In the method according to the first aspect of the present invention, the request information is a request for an inter-sidelink user equipment coordination message.

In the method according to the first aspect of the present invention, the request information is transmitted via SCI, or a MAC CE, or RRC signaling.

In the method according to the first aspect of the present invention, the coordination message at least comprises a resource set preferred by the first user equipment.

In the method according to the first aspect of the present invention, a resource selection mode of the first user equipment configured by a higher layer is a resource allocation mode based on random resource selection, or a resource allocation mode based on user (partial) sensing.

In the method according to the first aspect of the present invention, if the first user equipment does not receive the coordination message before a timer expires, then the first user equipment performs resource selection according to the resource allocation mode indicated by the higher layer, or otherwise, the first user equipment selects a transmission resource at least according to the preferred resource set.

In the method according to the first aspect of the present invention, the request information at least comprises a starting time of a resource selection window of the first user equipment.

In the method according to the first aspect of the present invention, if the first user equipment is at the starting time of the resource window, then the first user equipment performs resource selection according to the resource allocation mode indicated by the higher layer, or otherwise, the first user equipment selects a transmission resource at least according to the preferred resource set.

User equipment according to a second aspect of the present invention comprises: a processor; and a memory storing instructions, wherein the instructions, when run by the processor, perform the method according to the first aspect.

### Beneficial Effects of Present Invention

In NR sidelink enhancement, when user equipment B does not receive an inter-UE coordination message transmitted by user equipment A, the solution of the present patent ensures that user equipment B can effectively perform resource selection for sidelink transmission. The fallback mechanism ensures that user equipment B performs resource selection within a certain latency range, thereby reducing sidelink latency. Another solution of the present patent ensures that when user equipment A selects a resource for transmitting a coordination message, the selected transmission resource is within the foregoing certain latency range, thereby effectively improving sidelink reliability.

### BRIEF DESCRIPTION OF THE DRAWINGS

The above and other features of the present invention will be more apparent from the following detailed description in combination with the accompanying drawings, in which:

FIG. 1 is a schematic diagram showing sidelink communication of LTE V2X UE.

FIG. 2 is a schematic diagram showing a resource allocation mode of LTE V2X.

FIG. 3 is a schematic diagram showing a basic procedure of a method performed by user equipment according to Embodiment 1 of the invention.

FIG. 4 is a schematic diagram showing a basic procedure of a method performed by user equipment according to Embodiment 4 of the invention.

FIG. 5 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and later evolved versions thereof are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention use the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
LTE: Long Term Evolution
NR: New Radio
PDCCH: Physical Downlink Control Channel
DCI: Downlink Control Information
PDSCH: Physical Downlink Shared Channel
UE: User Equipment
eNB: evolved NodeB, evolved base station
gNB: NR base station
TTI: Transmission Time Interval
OFDM: Orthogonal Frequency Division Multiplexing
CP-OFDM: Cyclic Prefix Orthogonal Frequency Division Multiplexing
C-RNTI: Cell Radio Network Temporary Identifier
CSI: Channel State Information
HARQ: Hybrid Automatic Repeat Request
CSI-RS: Channel State Information Reference signal
CRS: Cell Reference Signal
PUCCH: Physical Uplink Control Channel
PUSCH: Physical Uplink Shared Channel
UL-SCH: Uplink Shared Channel
CG: Configured Grant
Sidelink: Sidelink communication
SCI: Sidelink Control Information
PSCCH: Physical Sidelink Control Channel
MCS: Modulation and Coding Scheme
RB: Resource Block
RE: Resource Element
CRB: Common Resource Block
CP: Cyclic Prefix
PRB: Physical Resource Block
PSSCH: Physical Sidelink Shared Channel
FDM: Frequency Division Multiplexing
RRC: Radio Resource Control
RSRP: Reference Signal Receiving Power
SRS: Sounding Reference Signal
DMRS: Demodulation Reference Signal
CRC: Cyclic Redundancy Check
PSDCH: Physical Sidelink Discovery Channel
PSBCH: Physical Sidelink Broadcast Channel
SFI: Slot Format Indication
TDD: Time Division Duplexing
FDD: Frequency Division Duplexing
SIB1: System Information Block Type 1
SLSS: Sidelink Synchronization Signal
PSSS: Primary Sidelink Synchronization Signal
SSSS: Secondary Sidelink Synchronization Signal
PCI: Physical Cell ID
PSS: Primary Synchronization Signal
SSS: Secondary Synchronization Signal
BWP: Bandwidth Part
GNSS: Global Navigation Satellite System
SFN: System (Radio) Frame Number
DFN: Direct Frame Number
IE: Information Element
SSB: Synchronization Signal Block
EN-DC: EUTRA-NR Dual Connection
MCG: Master Cell Group
SCG: Secondary Cell Group
PCell: Primary Cell
SCell: Secondary Cell
PSFCH: Physical Sidelink Feedback Channel
SPS: Semi-Persistent Scheduling
TA: Timing Advance
PT-RS: Phase-Tracking Reference Signal
TB: Transport Block
CB: Code Block
QPSK: Quadrature Phase Shift Keying
16/64/256 QAM: 16/64/256 Quadrature Amplitude Modulation
AGC: Automatic Gain Control
TDRA (field): Time Domain Resource Assignment indication (field)
FDRA (field): Frequency Domain Resource Assignment indication (field)
ARFCN: Absolute Radio Frequency Channel Number
SC-FDMA: Single Carrier-Frequency Division Multiple Access
MAC: Medium Access Control layer
DRX: Discontinuous Reception
MAC CE: MAC Control Element

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can equivalently replace each other. The resource allocation mode involved in the description can mean a transmission mode, and the transmission mode involved herein can mean a resource allocation mode. In NR sidelink, transmission mode 1 represents a base station scheduling-based transmission mode (resource allocation mode), and transmission mode 2 represents a user equipment sensing-based and resource selection-based transmission mode (resource allocation mode).

The PSCCH in the description of the present invention is used to carry SCI. The PSSCH associated with or related to or corresponding to or scheduled by PSCCH involved in the description of the present invention has the same meaning, and all refer to an associated PSSCH or a corresponding PSSCH. Similarly, the SCI (including first stage SCI and second stage SCI) associated with or related to or corresponding to PSSCH involved in the description has the same meaning, and all refer to associated SCI or corresponding SCI. It is worth pointing out that the first stage SCI, referred to as 1st stage SCI or SCI format 1-A, is transmitted in the PSCCH; and the second stage SCI, referred to as 2nd stage SCI or SCI format 2-A (or, SCI format 2-B), is transmitted on resources of the corresponding PSSCH.

In the description of the present invention, expiration of a timer indicates that the timer has been running for longer than the duration thereof, i.e., the timer expires.

### Numerologies in NR (Including NR Sidelink) and Slots in NR (Including NR Sidelink)

A numerology includes two aspects: a subcarrier spacing and a cyclic prefix (CP) length. NR supports five subcarrier spacings, which are respectively 15 kHz, 30 kHz, 60 kHz, 120 kHz, and 240 kHz (corresponding to μ=0, 1, 2, 3, 4). Table 4.2-1 shows the supported transmission numerologies, specifically as follows.

TABLE 4.2-1
Subcarrier Spacings Supported by NR

| μ | Δf = 2^{μ} · 15 [kHz] | CP (cyclic prefix) |
|---|---|---|
| 0 | 15 | Normal |
| 1 | 30 | Normal |
| 2 | 60 | Normal, extended |
| 3 | 120 | Normal |
| 4 | 240 | Normal |

Only when μ=2, namely, in the case of a 60-kHz subcarrier spacing, is the extended CP supported, and only the normal CP is supported in the case of other subcarrier spacings. For the normal CP, each slot includes 14 OFDM symbols; for the extended CP, each slot includes 12 OFDM symbols. For μ=0, namely, a 15-kHz subcarrier spacing, one slot=1 ms; for μ=1, namely, a 30-kHz subcarrier spacing, one slot=0.5 ms; for μ=2, namely, a 60-kHz subcarrier spacing, one slot=0.25 ms, and so on.

NR and LTE have the same definition for a subframe, which denotes 1 ms. For a subcarrier spacing configuration μ, a slot index in one subframe (1 ms) may be expressed as nₛ^{μ}, and ranges from 0 to Nₛₗₒₜ^{subframe,μ}−1. A slot index in one system frame (having a duration of 10 ms) may be expressed as n_{s,f}^{μ}, and ranges from 0 to Nₛₗₒₜ^{frame,μ}−1. Definitions of Nₛₗₒₜ^{subframe,μ} and Nₛₗₒₜ^{frame,μ} for different subcarrier spacings μ are shown in the tables below.

TABLE 4.3.2-1
the number of symbols included in each slot, the number
of slots included in each system frame, and the number
of slots included in each subframe for the normal CP

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4.3.2-2
the number of symbols included in each slot, the number of
slots included in each system frame, and the number of slots
included in each subframe for the extended CP (60 kHz)

| μ | N_{symb}^{slot} | Nₛₗₒₜ^{frame, μ} | Nₛₗₒₜ^{subframe, μ} |
|---|---|---|---|
| 2 | 12 | 40 | 4 |

On an NR carrier, a system frame (or simply referred to as frame) number (SFN) ranges from 0 to 1023. The concept of a direct system frame number DFN is introduced to sidelink, and the number likewise ranges from 0 to 1023. The above description of the relationship between the system frame and the numerology can also be applied to a direct system frame. For example, the duration of one direct system frame is likewise equal to 10 ms; for a 15 kHz subcarrier spacing, one direct system frame includes 10 slots, and so on. The DFN is applied to timing on a sidelink carrier.

### Parameter Sets in LTE (Including LTE V2X) and Slots and Subframes in LTE (Including LTE V2X)

The LTE only supports a 15 kHz subcarrier spacing. Both the extended CP and the normal CP are supported in the LTE. The subframe has a duration of 1 ms and includes two slots. Each slot has a duration of 0.5 ms.

For a normal CP, each subframe includes 14 OFDM symbols, and each slot in the subframe includes 7 OFDM symbols; for an extended CP, each subframe includes 12 OFDM symbols, and each slot in the subframe includes 6 OFDM symbols.

### Resource Block (RB) and Resource Element (RE)

The resource block (RB) is defined in the frequency domain as N_{SC}^{RB}=12 consecutive subcarriers. For example, for a 15 kHz subcarrier spacing, the RB is 180 kHz in the frequency domain. For a 15 kHz×2^{μ} subcarrier spacing, the resource element (RE) represents one subcarrier in the frequency domain and one OFDM symbol in the time domain.

### Sidelink Communication Scenario

1) Out-of-coverage sidelink communication: Both of two UEs performing sidelink communication are out of network coverage (for example, the UE cannot detect any cell that meets a “cell selection criterion” on a frequency at which sidelink communication needs to be performed, meaning that the UE is out of network coverage).
2) In-coverage sidelink communication: Both of two UEs performing sidelink communication are in network coverage (for example, the UE detects at least one cell that meets a “cell selection criterion” on a frequency at which sidelink communication needs to be performed, meaning that the UE is in network coverage).
3) Partial-coverage sidelink communication: One of two UEs performing sidelink communication is out of network coverage, and the other is in network coverage.

From the perspective of the UE side, the UE only has two scenarios, out-of-coverage and in-coverage. Partial-coverage is described from the perspective of sidelink communication.

### Basic Procedure of LTE V2X (Sidelink) Communication

FIG. 1 is a schematic diagram showing sidelink communication of LTE V2X UE. First, UE1 transmits to UE2 sidelink control information (SCI format 1), which is carried by a physical layer channel PSCCH. SCI format 1 includes scheduling information of a PSSCH, such as frequency domain resources and the like of the PSSCH. Secondly, UE1 transmits to UE2 sidelink data, which is carried by the physical layer channel PSSCH. The PSCCH and the corresponding PSSCH are frequency division multiplexed, that is, the PSCCH and the corresponding PSSCH are located in the same subframe in the time domain but are located on different RBs in the frequency domain. In LTE V2X, one transport block (TB) may include only one initial transmission, or include one initial transmission and one blind retransmission (indicating a retransmission not based on HARQ feedback).

Specific Design Methods of the PSCCH and the PSSCH are as Follows:
1) The PSCCH occupies one subframe in the time domain and two consecutive RBs in the frequency domain. Initialization of a scrambling sequence uses a predefined value of 510. The PSCCH may carry SCI format 1, wherein SCI format 1 at least includes frequency domain resource information of the PSSCH. For example, for a frequency domain resource indication field, SCI format 1 indicates a starting subchannel number and the number of consecutive sub-channels of the PSSCH corresponding to the PSCCH.
2) The PSSCH occupies one subframe in the time domain, and the PSSCH and the corresponding PSCCH are frequency division multiplexed (FDM). The PSSCH occupies one or a plurality of consecutive subchannels in the frequency domain. The subchannel represents N_{subCHsize} consecutive RBs in the frequency domain, N_{subCHsize} is configured by an RRC parameter, and a starting subchannel and the number of consecutive subchannels are indicated by a frequency domain resource indication field of SCI format 1.

### LTE V2X Resource Allocation Modes: Transmission Mode 3/Transmission Mode 4

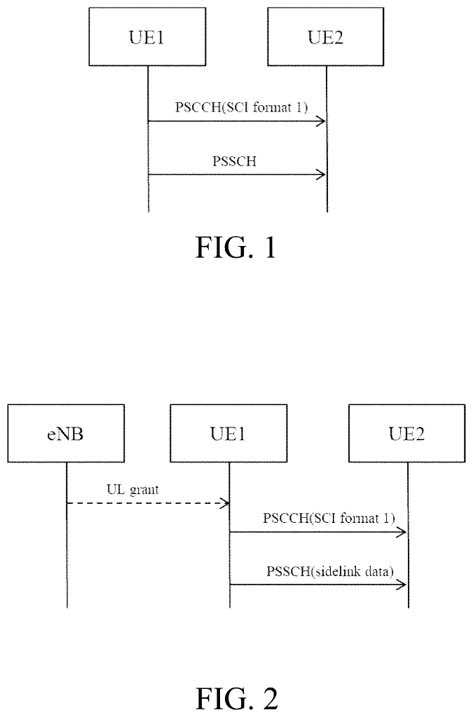

FIG. 2 shows two LTE V2X resource allocation modes, which are referred to as base station scheduling-based resource allocation (transmission mode 3) and UE sensing-based resource allocation (transmission mode 4), respectively. In NR sidelink, transmission mode 3 in LTE V2X corresponds to transmission mode 1 in NR V2X, and is a base station scheduling-based transmission mode, and transmission mode 4 in LTE V2X corresponds to transmission mode 2 in NR V2X, and is a UE sensing-based transmission mode. In LTE V2X, when there is eNB network coverage, a base station can configure, via UE-level dedicated RRC signaling SL-V2X-ConfigDedicated, a resource allocation mode of UE, which can alternatively be referred to as a transmission mode of the UE, and the specifics are as follows:
1) Base station scheduling-based resource allocation mode (transmission mode 3): the base station scheduling-based resource allocation mode means that frequency domain resources used in sidelink communication are scheduled by the base station. Transmission mode 3 includes two scheduling modes, which are dynamic scheduling and semi-persistent scheduling (SPS), respectively. For dynamic scheduling, a UL grant (DCI format 5A) includes frequency domain resources of a PSSCH, and a CRC of a PDCCH or an EPDCCH carrying the DCI format 5A is scrambled by an SL-V-RNTI. For SPS, the base station configures one or a plurality of (at most eight) configured grants through IE: SPS-ConfigSL-r14, and each configured grant includes a grant index and a resource period of the grant. The UL grant (DCI format 5A) includes the frequency domain resource of the PSSCH, indication information (three bits) of the grant index, and indication information of SPS activation or release (or deactivation). The CRC of the PDCCH or the EPDCCH carrying the DCI format 5A is scrambled by an SL-SPS-V-RNTI.
   Specifically, when RRC signaling SL-V2X-ConfigDedicated is set to scheduled-r14, same indicates that the UE is configured in the base station scheduling-based transmission mode. The base station configures the SL-V-RNTI or the SL-SPS-V-RNTI via RRC signaling, and transmits the uplink (UL) grant to the UE via the PDCCH or the EPDCCH (DCI format 5A, the CRC being scrambled by the SL-V-RNTI or the SL-SPS-V-RNTI). The UL grant at least includes scheduling information of the PSSCH frequency domain resource in sidelink communication. When the UE successfully detects the PDCCH or the EPDCCH scrambled by the SL-V-RNTI or the SL-SPS-V-RNTI, the UE uses a PSSCH frequency domain resource indication field in the UL grant (DCI format 5A) as PSSCH frequency domain resource indication information in a PSCCH (SCI format 1), and transmits the PSCCH (SCI format 1) and a corresponding PSSCH.
   For SPS in transmission mode 3, the UE receives, on a downlink subframe n, the DCI format 5A scrambled by the SL-SPS-V-RNTI. If the DCI format 5A includes the indication information of SPS activation, then the UE determines frequency domain resources of the PSSCH according to the indication information in the DCI format 5A, and determines time domain resources of the PSSCH (transmission subframes of the PSSCH) according to information such as the subframe n and the like.
2) UE sensing-based resource allocation mode (transmission mode 4): the UE sensing-based resource allocation mode means that resources for sidelink communication are based on a procedure of sensing, by the UE, a candidate available resource set. When the RRC signaling SL-V2X-ConfigDedicated is set to ue-Selected-r14, it indicates that the UE is configured in the UE sensing-based transmission mode. In the UE sensing-based transmission mode, the base station configures an available transmission resource pool, and the UE determines a PSSCH sidelink transmission resource in the transmission resource pool according to a certain rule (for a detailed description of the procedure, see the LTE V2X UE sensing procedure section), and transmits a PSCCH (SCI format 1) and a corresponding PSSCH.

### Sidelink Resource Pool

In sidelink, resources transmitted and received by UE all belong to resource pools. For example, for a base station scheduling-based transmission mode in sidelink, the base station schedules transmission resources for sidelink UE in a resource pool; alternatively, for a UE sensing-based transmission mode in sidelink, the UE determines a transmission resource in a resource pool.

### Resource Allocation Mode Based on (Partial) Sensing

For a resource allocation mode based on (partial) sensing, sidelink user equipment selects a candidate resource within one time window, determines, according to a reserved resource indicated by a PSCCH transmitted by other user equipment in a monitoring slot, candidate resources overlapping with the reserved resource, and excludes the foregoing candidate resources overlapping with the reserved resource. The physical layer reports, to the MAC layer, a set of candidate resources that are not excluded, and the MAC layer selects transmission resources for the PSSCH/PSCCH. The set of the transmission resources selected by the MAC layer is referred to as a selected sidelink grant.

The resource allocation mode based on sensing is referred to as resource allocation mode 2, indicating that the user equipment monitors, in all slots excluding each slot transmitted by the user equipment itself, PSCCHs transmitted by other sidelink UEs. For the resource allocation mode based on partial sensing, the user equipment only monitors, in the time domain, PSCCHs transmitted by other UEs in some slots.

### Resource Allocation Mode Based on Random Resource Selection

The resource allocation mode based on random resource selection indicates that the MAC layer of the user equipment randomly selects a resource for sidelink transmission. The physical layer may provide a resource set for resource selection to the MAC layer.

Resource Selection Window [n+T1, n+T2]

In a resource allocation mode based on sensing (or, partial sensing), a higher layer requests or triggers, in a slot n, the physical layer to determine a resource for PSSCH/PSCCH transmission (to perform sensing or partial sensing). The resource selection window is defined as [n+T1, n+T2]. That is, user equipment selects a transmission resource within the foregoing window. T1 satisfies the condition 0≤T1≤T_{proc,1}^{SL}, and the selection of T1 is up to user equipment implementation. RRC configuration information includes a resource selection window configuration list sl-SelectionWindow List, and an element on the list and corresponding to a given priority priorx (a priority of transmitting the PSSCH) is represented by T₂ₘᵢₙ. If T₂ₘᵢₙ is less than a remaining packet delay budget (PDB), then T2 satisfies the condition T₂ₘᵢₙ≤T2≤remaining PDB, and the selection of T2 is up to user equipment implementation; otherwise, T2 is set to the remaining PDB. T_{proc,1}^{SL} is defined as follows (μ_{SL} represents a sidelink subcarrier spacing parameter, that is, the subcarrier spacing is 2^{μSL}×15 kHz):

TABLE 8.1.4-2
Values of T_{poc, 1}^{SL}

| μ_{SL} | T_{poc, 1}^{SL} [Slot] |
|---|---|
| 0 | 3 |
| 1 | 5 |
| 2 | 9 |
| 3 | 17 |

TABLE 8.1.4-1
Values of T_{poc, 0}^{SL}

| μ_{SL} | T_{poc, 0}^{SL} [Slot] |
|---|---|
| 0 | 1 |
| 1 | 1 |
| 2 | 2 |
| 3 | 4 |

### Inter-UE Coordination

Inter-UE coordination supports the following two schemes:
Inter-UE coordination scheme 1: a coordination message transmitted by UE A to UE B is an indication of a resource set. The resource set includes resources preferred for UE B's transmission, and/or resources non-preferred for UE B's transmission.
Inter-UE coordination scheme 2: a coordination message transmitted by UE A to UE B indicates that an expected (or potential) resource conflict is present on a resource indicated by SCI transmitted by UE B, and/or indicates that a detected resource conflict is present on a resource indicated by SCI transmitted by UE B.

In the description of the present invention, UE A transmitting the coordination message and UE B receiving the coordination message are both referred to as sidelink user equipment.

### Latency Requirement of the Inter-UE Coordination Message

In the description of the present invention, the meaning of selecting a resource according to the latency requirement of the coordination message includes, but is not limited to: configuring or pre-configuring, or predefining, or giving a latency bound. Assuming that the time when user equipment B transmits a request message to user equipment A is T, then the selected time-frequency resource will not be later than T+latency bound in the time domain.

In the description of the present invention, the duration of a timer may be equal to the above-described latency bound.

Hereinafter, specific examples and embodiments related to the present invention are described in detail. In addition, as described above, the examples and embodiments described in the present disclosure are illustrative descriptions for facilitating understanding of the present invention, rather than limiting the present invention.

### Embodiment 1

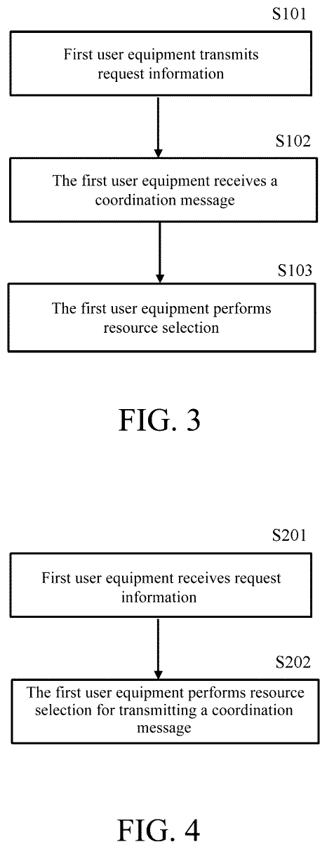

FIG. 3 is a schematic diagram showing a basic procedure of a method performed by user equipment according to Embodiment 1 of the present invention.

The method performed by user equipment according to Embodiment 1 of the present invention is described in detail below in conjunction with the basic procedure diagram shown in FIG. 3.

As shown in FIG. 3, in Embodiment 1 of the present invention, the steps performed by user equipment include the following:

In step S101, first user equipment transmits request information to second user equipment.

Optionally, the request information is a request for an inter-sidelink user equipment coordination message (inter-UE coordination message).

Optionally, the request information is transmitted via SCI, or a MAC CE, or RRC signaling.

The time of transmitting the request information is denoted as T.

Optionally, the first user equipment starts a timer.

In step S102, optionally, the first user equipment receives the coordination message.

Optionally, the coordination message at least includes a preferred resource set for the first user equipment.

In step S103, the first user equipment performs resource selection.

Optionally, a resource selection mode of the first user equipment configured by an upper layer (or a higher layer) is a resource allocation mode based on random resource selection, or a resource allocation mode based on user (partial) sensing.

Optionally, if the first user equipment does not receive the coordination message before the timer expires (i.e., time T+the duration of the timer), then, optionally, the first user equipment performs resource selection according to the resource allocation mode indicated by the higher layer, or otherwise, the first user equipment selects a transmission resource at least according to the preferred resource set. Optionally, the duration of the timer is configured or pre-configured, or predefined, or given.

Alternatively,

optionally, if the first user equipment does not receive the coordination message before time T+a time length (Interval), then, optionally, the first user equipment performs resource selection according to the resource allocation mode indicated by the higher layer, or otherwise, the first user equipment selects a transmission resource at least according to the preferred resource set. The time length (Interval) indicates a configured or pre-configured, or predefined, or given duration.

### Embodiment 2

In Embodiment 2 of the present invention, the steps performed by user equipment include:

In step 1, first user equipment transmits request information to second user equipment.

Optionally, the request information is a request for an inter-sidelink user equipment coordination message (inter-UE coordination message).

Optionally, the request information at least includes indication information of a resource selection window of the first user equipment. Optionally, the indication information includes a starting time of the resource selection window, or the second user equipment determines a starting time of the resource selection window according to the indication information.

Optionally, the request information is transmitted via SCI, or a MAC CE, or RRC signaling.

In step 2, optionally, the first user equipment receives the coordination message.

Optionally, the coordination message at least includes a preferred resource set for the first user equipment.

In step 3, the first user equipment performs resource selection.

Optionally, a resource selection mode of the first user equipment configured by an upper layer (or a higher layer) is a resource allocation mode based on random resource selection, or a resource allocation mode based on user (partial) sensing.

Optionally, if the first user equipment does not receive the coordination message before the starting time of the resource window, or a starting time −T_{proc,0}^{SL} of the resource window, or a starting time −T_{proc,1}^{SL} of the resource window, or a starting time −T_{proc,0}^{SL}−T_{proc,1}^{SL} of the resource window, then, optionally, the first user equipment performs resource selection according to the resource allocation mode indicated by the higher layer, or otherwise, the first user equipment selects a transmission resource at least according to the preferred resource set.

### Embodiment 3

In Embodiment 3 of the present invention, the steps performed by user equipment include:

In step 1, first user equipment transmits request information to second user equipment.

Optionally, the request information is a request for an inter-sidelink user equipment coordination message (inter-UE coordination message).

Optionally, the request information at least includes indication information of a resource selection window of the first user equipment.

Optionally, the request information is transmitted via SCI, or a MAC CE, or RRC signaling.

In step 2, optionally, the first user equipment receives the coordination message.

Optionally, the coordination message at least includes a preferred resource set for the first user equipment.

In step S103, the first user equipment performs resource selection.

Optionally, a resource selection mode of the first user equipment configured by an upper layer (or a higher layer) is a resource allocation mode based on random resource selection, or a resource allocation mode based on user (partial) sensing.

Optionally, if the first user equipment (at the current time) has not acquired (or, has not received) any available coordination message, then, optionally, the first user equipment performs resource selection according to the resource allocation mode indicated by the higher layer, or otherwise, the first user equipment selects a transmission resource at least according to the preferred resource set. Optionally, the available coordination message indicates that the preferred resource set is completely or partially located in the resource window in the time domain.

### Embodiment 4

FIG. 4 is a schematic diagram showing a basic procedure of a method performed by user equipment according to Embodiment 4 of the present invention.

The method performed by user equipment according to Embodiment 4 of the present invention is described in detail below in conjunction with the basic procedure diagram shown in FIG. 4.

As shown in FIG. 4, in Embodiment 4 of the present invention, the steps performed by the user equipment include:

In step S201, first user equipment receives request information transmitted by second user equipment.

Optionally, the request information is a request for an inter-sidelink user equipment coordination message (inter-UE coordination message).

Optionally, the request information is transmitted via SCI, or a MAC CE, or RRC signaling.

In step S202, the first user equipment performs resource selection, optionally, the resource selection being used for transmitting the coordination message.

Optionally, the coordination message at least includes a preferred resource set for the second user equipment.

Optionally, the first user equipment selects a time-frequency resource at least according to a latency requirement for transmitting the coordination message (latency requirement of the inter-UE coordination message), optionally, the time-frequency resource being used for one or more sidelink transmission opportunities.

### Embodiment 5

In Embodiment 5 of the present invention, the steps performed by user equipment include:

In step 1, first user equipment receives request information transmitted by second user equipment.

Optionally, the request information is a request for an inter-sidelink user equipment coordination message (inter-UE coordination message).

Optionally, the request information at least includes indication information of a resource selection window of the second user equipment. Optionally, the indication information includes a starting time of the resource selection window, or the first user equipment determines a starting time of the resource selection window according to the indication information.

Optionally, the request information is transmitted via SCI, or a MAC CE, or RRC signaling.

In step 2, the first user equipment performs resource selection, optionally, the resource selection being used for transmitting the coordination message.

Optionally, the coordination message at least includes a preferred resource set for the second user equipment.

Optionally, the first user equipment selects a time-frequency resource, so that the time-frequency resource, in the time domain, is at least before the starting time of the resource window, or a starting time −T_{proc,0}^{SL} of the resource window, or a starting time −T_{proc,1}^{SL} of the resource window, or a starting time −T_{proc,0}^{SL}−T_{proc,1}^{SL} of the resource window.

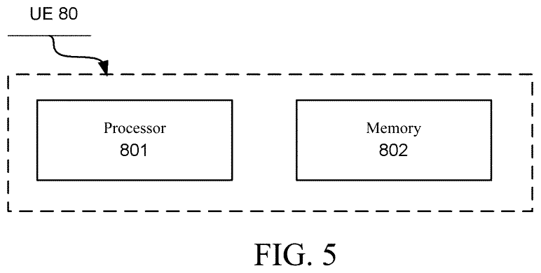

FIG. 5 shows a block diagram of user equipment (UE) according to the present invention. As shown in FIG. 5, user equipment (UE) 80 includes a processor 801 and a memory 802. The processor 801 may include, for example, a microprocessor, a microcontroller, an embedded processor, and the like. The memory 802 may, for example, include a volatile memory (for example, a random access memory (RAM)), a hard disk drive (HDD), a non-volatile memory (for example, a flash memory), or other memories. The memory 802 has program instructions stored thereon. The instructions, when run by the processor 801, can perform the above method performed by user equipment as described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers shown above are only exemplary, and are not meant for limiting the present invention. The present invention is not limited to specific information elements serving as examples of these identifiers. Those skilled in the art could make various alterations and modifications according to the teachings of the illustrated embodiments.

It should be understood that the above-described embodiments of the present invention may be implemented by software, hardware, or a combination of software and hardware. For example, various components of the base station and user equipment in the above embodiments can be implemented through multiple devices, and these devices include but are not limited to: an analog circuit device, a digital circuit device, a digital signal processing (DSP) circuit, a programmable processor, an application-specific integrated circuit (ASIC), a field-programmable gate array (FPGA), and a complex programmable logic device (CPLD), and the like.

In the present application, the “base station” may refer to a mobile communication data and control exchange center having large transmission power and a wide coverage area, including functions such as resource allocation and scheduling and data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic enables the processor to execute the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database, and so on in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application-specific integrated circuits (ASICs) or general-purpose integrated circuits, field-programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-4. (canceled)

5. A user equipment (UE), comprising:
a processor; and
a memory storing instructions, wherein the instructions, when run by the processor, perform
determining resources for sidelink transmission of an Inter-UE coordination message upon receiving the request for the Inter-UE coordination message based on at least a latency requirement of the Inter-UE coordination message.

6. A method performed by a user equipment (UE), the method comprising:
determining resources for sidelink transmission of an Inter-UE coordination message upon receiving the request for the Inter-UE coordination message based on at least a latency requirement of the Inter-UE coordination message.
